(19) United States
(12) Patent Application Publication
(10) Pub. No.: US 2009/0149262 A1
(43) Pub. Date: Jun. 11, 2009

(54) SYSTEM AND METHOD FOR COMMUNICATING AND COMPILING GAME PLAY INFORMATION

(75) Inventors: John R. Martin, Rockford, IL (US); Patrick G. Rice, Loves Park, IL (US)

Correspondence Address: MCANDREWS HELD & MALLOY, LTD, 500 WEST MADISON STREET, SUITE 3400, CHICAGO, IL, 60661, US

(73) Assignee: ARACHNID INC., Rockford, IL (US)

(21) Appl. No.: 11/953,315

(22) Filed: Dec. 10, 2007

(51) Int. Cl. G06F 17/00

(52) U.S. Cl. 463/43

(57) ABSTRACT

Embodiments of the present invention generally relate to entertainment systems, and more particularly to a system and method for, inputting and compiling information relating to game play at one or more game units. Game play information may be inputted into a communicator through the use of a user interface. According to some embodiments, a game play template may be used to input the game play information in the communicator. A variety of different methodologies, depending on the type of communicator utilized, may be used to communicate the inputted game play information to a host game server, including, but not limited to, MMS, SMS texting, WAP, or any other such portable text messaging or worldwide web accessible functionality. Opponents may have an opportunity to edit and validate the inputted game play information. Recorded game play information or league reports may be communicated to the communicator.

### BACKGROUND OF THE INVENTION

Embodiments of the present invention generally relate to entertainment systems, and more particularly to a system and method for, among other things, inputting and compiling information relating to game play at one or more game units. Embodiments of the present invention are particularly suited for competitive or league game play for a variety of game units, including, but not limited to, a billiard table, dartboard, bowling, and table hockey games, among others.

Game play information recorded for purposes of tracking competitive game play, and particularly for use in team or player game leagues, often includes, but is not limited to, game play information on a game by game basis, match results, an identification of the individual players, team, and opponents, and an indication of various feats or accomplishments achieved during game play. However, traditional game units typically require that the recording of game play results be done by a player or other individual writing on a score sheet, or that some other hand-written record be created. Moreover, traditional game units, such a billiard tables, are typically not manufactured with the feature of an automatic scoring system because the inclusion of such a feature is generally cost prohibitive. Accordingly, the recording of game play information at such game units typically requires a player or other individual to create a hand-written record of game play information.

Upon the completion of game play at such game units, the filled-out score sheets (or other form of written record) may be given to the location attendant or other individual, or inserted into a slot on a designated machine or collection box. In some instances, during route revenue collections, these score sheets may be picked up at each location where league game play has occurred. The written records are then delivered to the office managing the league for collation and processing. League reports may then be generated from the various game play records, such as standings, which may be sorted in various ways to show team and player rankings. These league reports may then be mailed to each of the location(s) of league play, or delivered during the next collection of the hand-written score sheets.

Generally, a significant amount of time elapses between actual game play and the players receiving the league reports. This delay may adversely affect the players' gratification with his or her participation in competitive play. Further, this delay may adversely affect the revenue generated at the facility hosting game play. For example, if updated league information were readily available shortly after the conclusion of game play, or within the next several days, players may be more inclined to remain at, or return to, the hosting facility for the league report, and thus spend more money at the hosting facility, such as expenditures on game play, beverages, and food before the next scheduled league match or event.

### BRIEF SUMMARY OF THE INVENTION

Embodiments of the present invention provide an entertainment system that may reduce the time between the completion of game play at a game unit and the availability of corresponding updated league information. Further, embodiments of the present invention also provide an entertainment system comprising of a game unit, for example a billiard table, and at least one communicator. The communicator may be portable, mounted to a wall, or mounted to the game unit. Further, the communicator may be dedicated for use with a game unit(s) at the facility offering game play, or may be a hand-held personal electronic device or a computer.

A player or other individual may input game play information into the communicator through the use of a user interface. The user interface may include a display, at least one player switch, and a central processing unit. The at least one switch may be a keypad, keyboard, button, or touch screen, among others. According to some embodiments, game play information may be inputted into the communicator through the use of a template that may be downloaded from the host game server, or which may be programmed into the communicator. Game play information inputted into the communicator may be communicated by the communication interface to the host game server before, during, or after a game(s) or match. Further, according to certain embodiments, an opposing player may have the opportunity to review, edit, and/or validate the inputted game play information before or after it is communicated to the host game server.

The communicator may include a communication interface that may transmit information to, or receive transmissions from, a host game server. According to some embodiments, the communicator may communicate with the host game server through a wireless radio frequency (RF), including, but not limited to, a proprietary RF or Bluetooth technology. According to other embodiments, the communicator may communicate with the host game server through the use of Short Message Server (SMS) texting, Multimedia Messaging Service (MMS), or may utilize a Wireless Application Protocol (WAP), Wireless Markup Language (WML), or any other such portable text messaging or worldwide web accessible functionality to communicate with the host game server. According to certain embodiments, the communicator may be, but is not limited to, a wireless web accessible computer laptop, cellular telephone, or personal digital assistant, among others. According to other embodiments, the communicator may be a computer. Embodiments of the present invention also provide a method of communicating game play information to a host game server through the use of the system communicator of a second entertainment system. Game play information transmitted between the system communicator and the host game server may include, but is not limited to, game play information, such as information regarding fees, payments, teams, players, scores, standings, and games to play.

### BRIEF DESCRIPTION OF SEVERAL VIEWS OF THE DRAWINGS

FIG. 1 illustrates a simplified representation of an entertainment system according to one embodiment of the present invention.

FIG. 2a illustrates a flow chart of a method for reporting game play information utilizing SMS texting according to an embodiment of the present invention.

FIGS. 2b-2e illustrates an example of inputting game play information utilizing SMS texting as shown on the display of a communicator according to an embodiment of the present invention.

FIG. 3 illustrates a flow chart of a method for reporting game play information utilizing a portable communicator and WAP, WML, or other worldwide web accessible functionality according to an embodiment of the present invention.

FIG. 4 illustrates a flow chart of a method for reporting game play information utilizing worldwide web accessibility according to an embodiment of the present invention.

FIG. 5a illustrates an embodiment of the present invention in which a second entertainment system is used for communicating information relating to game play at a first entertainment system according to an embodiment of the present invention.

FIG. 5b illustrates an example of a game play template displayed on the display of the user interface of a second entertainment system according to one embodiment of the present invention.

FIG. 5c illustrates a flow chart of a method for reporting game play information at a first entertainment system utilizing the communication capabilities of a second entertainment system according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

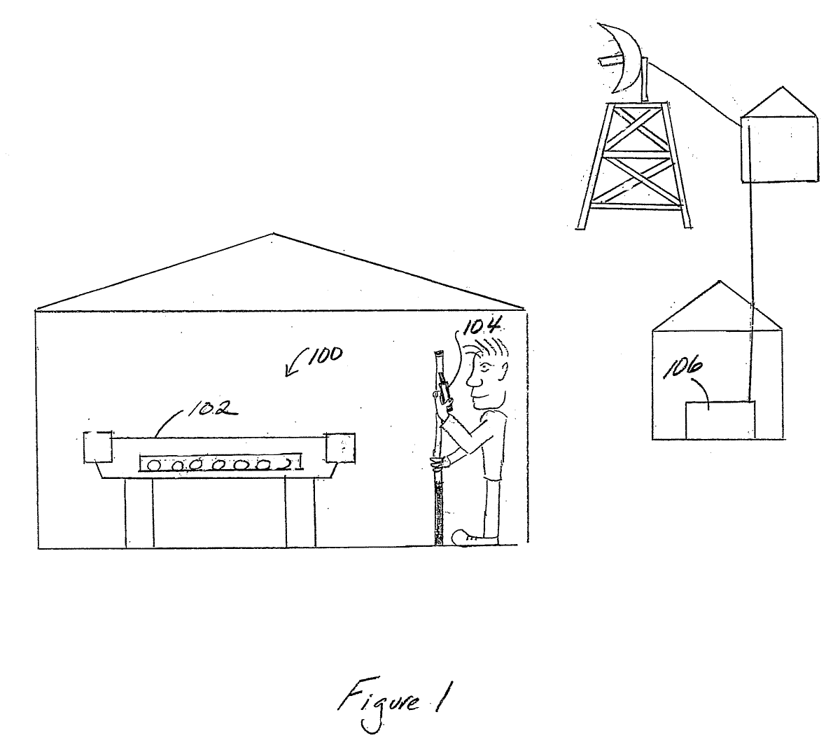

FIG. 1 illustrates a simplified representation of an entertainment system 100 comprising a game unit 102, for example a billiard table, and a communicator 104, according to one embodiment of the present invention. The communicator 104 may include a communication interface, for example an RF module or transceiver that may transmit and/or receive transmissions from a host game server 106. The host game server 106 may be at a location remote from where game play is occurring and/or where the communicator 104 is located, as shown in FIG. 1, or may be located at the same facility.

The communicator 104 may be a portable device, for example, a battery-operated device that is dedicated for use with one or more game units. According to some embodiments, the communicator 104 may be a cellular telephone or other hand-held personal electronic device, such as a personal digital assistant, among others. According to other embodiments, the communicator 104 may be a floor or table-standing unit, mounted to a wall, or be operably mounted to the game unit 102. Further, the communication interface of the communicator 104 may communicate with the host game server 106 through of a variety of functionalities. For example, according to some embodiments of the present invention, the communication interface may communicate with the host game server 106 through the use of a wireless RF signal, including, but not limited to, a proprietary RF or Bluetooth technology. Alternatively, the communicator 104 may be inserted into, or connected by wires to, a docking station, which may allow for information to be uploaded and/or downloaded from the communicator 104 and host game server 106.

According to embodiments of the present invention, the communicator 104 may also include a user interface. The user interface may include a display and at least one player switch, such as a keypad, touch screen, or buttons, among others, that allows an individual to input game play information into the communicator 104. Game play information inputted into the communicator 104 may be communicated via the communication interface to the host game server 106, such as information regarding game or league fees, payments, teams, players, scores, standings, and/or games to play, among others.

The host game server 106 may save the game play information it receives from the communicator 104. The host game server 106 may also be programmed to compile the received game play information to determine league or competitive play information, such as team standings, player rankings, handicaps, future schedules, and required payments, among others. Moreover, the host game server 106 may be programmed to communicate such compiled information to league managers, team captains, individual players, or other individuals. For example, the host game server 106 may be programmed to communicate the received game play information or the compiled information to the communicator 104 or other electronic devices or electronic storage mediums. For example, the host game server 106 may be programmed to send e-mails or faxes containing the compiled information to designated individuals and/or the participants in game play. Information stored on the host game server 106 may also be accessed by a computer that is operably connected to the host game server 106. Moreover, the host game server 106 may allow the recorded and/or compiled game play information to be accessed through a website.

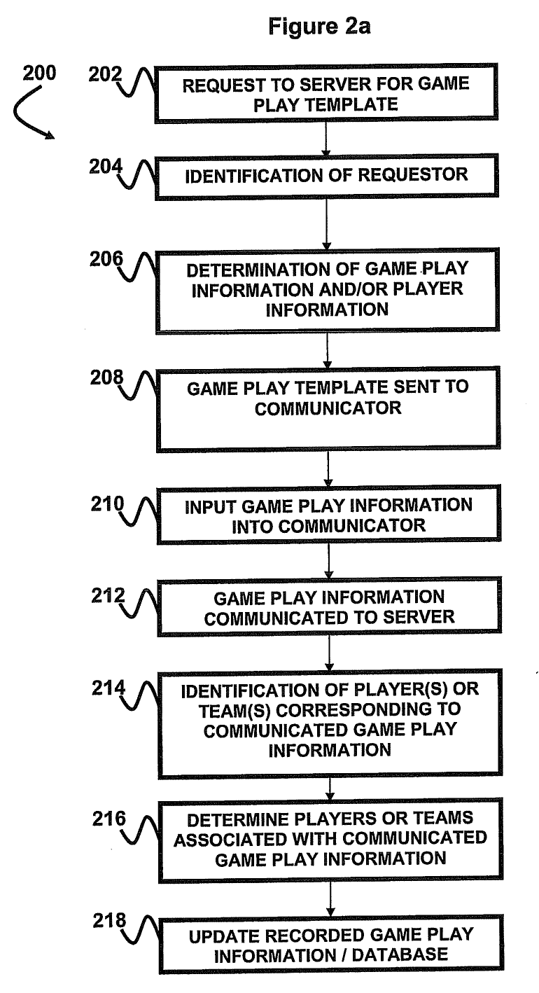

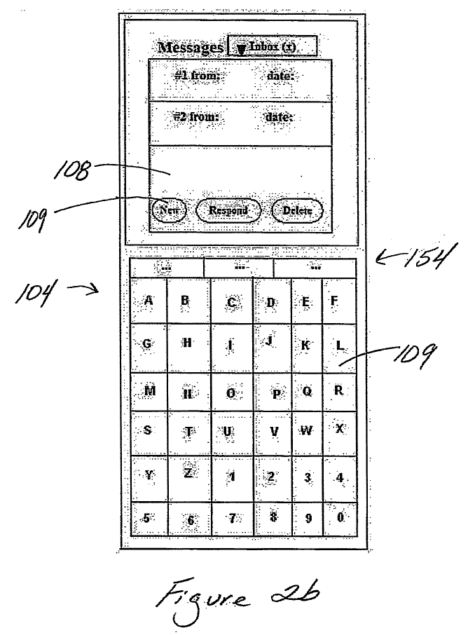

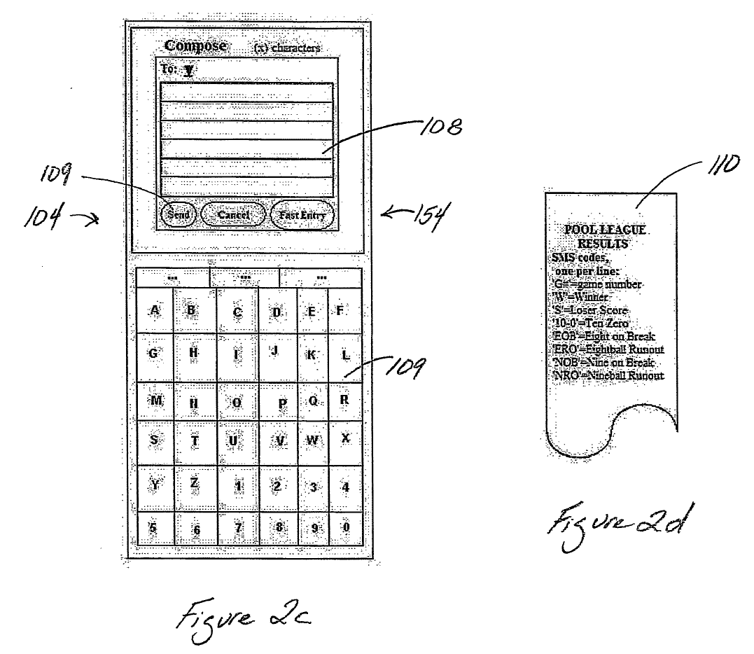

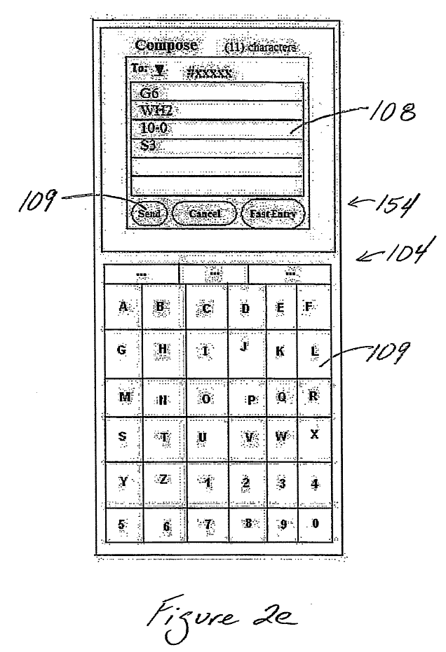

FIG. 2a illustrates a flow chart of a method 200 for reporting game play information utilizing SMS texting according to an embodiment of the present invention. At 202, a player or other individual may use the communicator 104 to send a message via SMS texting to a host game server 106 requesting a game or match play template. The game play template may be an SMS template that has a variety of different formats that may allow the player to record a variety of game play information, such as player names, team names, scores, wins, losses, and accomplishments or feats, among others. The game play template may be used to record game play information before, during, and/or after game play. Traditional paper, such as traditional paper score sheets, may continue to be used as a temporary scratch pad before game play information is submitted to the host game server 106 from the communicator 104.

At 204, the host game server 106 may request or obtain information regarding the identity of the requesting player(s), team(s), communicator 104, or game play location. For example, according to some embodiments in which the communicator 104 is a cellular telephone, the host game server 106 may use caller identification information, such as the telephone number of the cellular telephone or the name associated with the cellular telephone or number, to determine the identity of the caller. Alternatively, the host game server 106 may prompt the individual to input and communicate to the host game server 106 identification information, for example, a password, name, team name, game play location, game play time, game unit 102 information, and/or e-mail address, among others, that enables the host game server 106 to identify the requestor of the game play template and/or whether that individual is permitted to receive a game play template.

At 206, the host game server 106 may use the identification information to determine information related to the game play. For example, the server may use the identification information to determine the player's league and/or team. The host game server 106 may also then identify the opposing player or team, either by selecting the opposition from available options or by referring to the league schedule. The host game server 106 may then locate or create the requested formatted game play template.

At 208, the host game server 106 may send the game play template to the communicator 104. According to certain embodiments, the game play template may be stored on the communicator 104, for example by a central processing unit or microprocessor, so that, for each subsequent game or match, a game play template may be retrieved from the communicator 104 without having to communicate another request for a game play template from the host game server 106. Accordingly, after a player has inputted game play information into the game play template on the communicator 104, and that the game play information has been communicated from the communication interface to the host game server 106, the player may retrieve a game play template that is stored on the communicator 104 to record subsequent game play information. However, according to other embodiments of the present invention, the communicator 104 may be pre-programmed to provide a formatted game play template for reporting game play information.

At 210, upon the completion of each game or the completion of the match, the player, team captain, or another individual may enter the game play information into the communicator 104. According to some embodiments, rather than use a game play template for inputting game play results, the player may be provided with instructions as to the proper format for inputting game play information into the communicator 104. For example, FIG. 2b illustrates a representation of a display 108 of a communicator 104 that utilizes SMS texting to communicate game play results to the host game server 106. As shown in FIG. 2b, the individual has the option of creating a new SMS text message by selecting the “new” option, as shown on the display 108, by engaging the corresponding player input switch 109, which may be a keypad, touch screen, toggle switch, and/or button, among others. After selecting the “new” option, a new message template may be displayed on the display 108, as shown in FIG. 2c. The new message template may display areas for entry of text or data, and in particular areas or lines for the entry of game play information.

Game play information may be entered into the communicator 104 with the use of codes, which may allow the host game server 106 to appropriately record the game play information. Instructions for inputting game play information in the communicator 104, and the associated codes, may be provided, such as in the form of a decal 110 that is attached to the game unit 102, as shown in FIG. 2d. According to the embodiment illustrated in FIG. 2d, each reported detail of game play information may be entered on a single line. As shown, codes may include, but are not limited to, “G” for game number, “W” for an identification of the winner, “S” for the score of the losing player, and “10-0,” “EOB,” “ERO,” “NOB,” and “NRO” for reporting various accomplishments and feats.

FIG. 2e illustrates an example of a display 108 showing game play information that has been inputted into the communicator 104. As shown, the inputted game play information relates to billiard game number 6 (“G6”), the winner being home team player number 2 (“WH2”) (which could also be designated by the individual's or team's actual name), the accomplishment of a ten zero, and the loser pocketing three balls (“S3”). Further, the recipient shown in FIG. 2e (“#xxxxx”) may correspond to the league number to which the inputted game play information is to be communicated. However, rather than enter the codes, the player may select the “Fast Entry” option, which may allow result codes to be selected from a list of available codes. According to certain embodiments, the codes may be in a bold format that may not be edited by the player.

Referring to FIG. 2a, at 212, game play information is communicated from the communicator 104 through the communication interface to the host game server 106. At 214, the host game server 106 may identify the individual, team, or communicator 104 that sent the game play information. For example, the game play template may include identification information or a code(s) that may identify which player(s) and/or team(s) are related to the submitted game play information. According to another embodiment, the host game server 106 may utilize caller identification information to identify the communicator 104 and determine the player(s) or team(s) associated with the submitted game play information.

At 216, the host game server 106 may refer to league information, such as the league schedule, to determine other information, such as the corresponding league for the communicated game play information and/or the opposing team. However, according to certain embodiments, this information may already be provided in the communicated game play information. According to certain embodiments, opponents or a member from both teams may review, edit, and/or validate the game play results inputted into the communicator 104 before the results are communicated to the host game server 106. Alternatively, an opponent or other individual may receive the communicated game play information from the host game server before that game play information is recorded as the final results of the game play, and thereby may be given an opportunity to edit, verify, and/or dispute the communicated game play information. At 218, the host game server 106 may use the submitted game play information to update a league database or tables, including information such as, but not limited to, league standings and player or team records and ranks.

However, rather than use SMS text messaging as discussed above, game play information may be communicated from the communicator 104 to the host game server 106 through the use of a Multimedia Messaging Service (MMS) standard. Accordingly, game play information may be transmitted from the communicator 104 to the host game server 106 as a multimedia object, for example as an image, video, audio, or text file, among others. For example, an individual may communicate a picture of a score sheet (such as in a JPEG or GIF formatted file, among others) that contains game play information from the communicator 104 to the host game server 106. Alternatively, game play information may be communicated to the host game server 106 by an individual speaking into a communicator 104 that is connected to the host game server 106. According to other embodiments, an audio file containing game play information may be communicated to the host game server 106 (such as a MP3 or MIDI formatted file, among others). Alternatively, game play information may be communicated from the communicator 104 to the host game server 106 as a video, for example as a MPEG file, among others. Additionally, game play information may be communicated to the host game server in a combination of both the SMS and MMS standards. For example, information relating to the players may be in the form of an SMS text message, and information about the players' scores and feats may be in the MMS format, or vice-versa. The game host server 106, or other component operably connected to the game host server 106, may be programmed to translate the game play information communicated in the MMS format to a format that may be used to record the game play information and/or update the corresponding database.

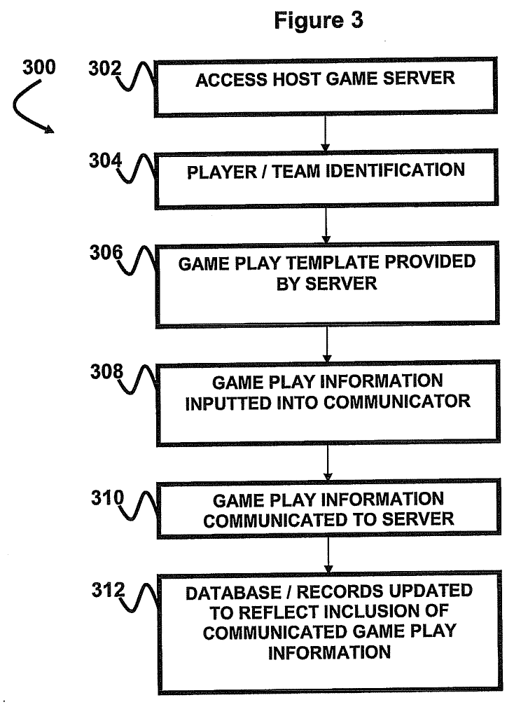

FIG. 3 illustrates a flow chart of a method 300 for reporting game play information utilizing a portable communicator 104 and WAP, WML, or other worldwide web accessible functionality according to an embodiment of the present invention. At 302, an individual, including, but not limited to, a player, team captain, facility employee, or league manager, may, use of the communicator 104 to log into the league host game server 106 to enter game play information. The entry of game play information may occur at a variety of different times, including, but not limited to, before, during, or after the completion of a game or match.

At 304, the host game server 106 may use the information transmitted from the communicator 104 to identify the player, team, league, operator, or facility that is logging onto the host game server 106. Moreover, the information transmitted to the host game server 106, such as the information inputted by the individual when logging into the host game server 106, an identification of the communicator 104, or an internet protocol address, among others, may be used by the host game server 106 to retrieve player or league specific information. For instance, the information submitted when logging into the host game server 106, such as entering a password, user name, and/or caller identification, may be used by the host game server 106 to determine the identity of the player(s), team(s), and/or league. Further, based on the inputted information and the league schedule, the host game server 106 may be able to determine the identity of the opponent(s).

At 306, the host game server 106 may provide to the communicator 104 a game play template for entry of the game play information. At 308, game play information is inputted, through the use of the user interface 154, into the communicator 104. At 310, the inputted game play information may be communicated from the communicator 104 through the communication interface to the host game server 106. Further, the opposing player or team may also be given an opportunity to review, validate, and/or edit, the inputted game play information before or after it is submitted to the host game server 106. For example, the opposing player may have access to the communicator 104 that the game play information is initially inputted into, or may have a communicator that receives the inputted game play information, so that that player may edit, review, and/or validate the inputted game play information. At 312, the game host sever 106 may utilize the communicated game play information to update the database and/or records, such as updating league standings and player ranks, among others.

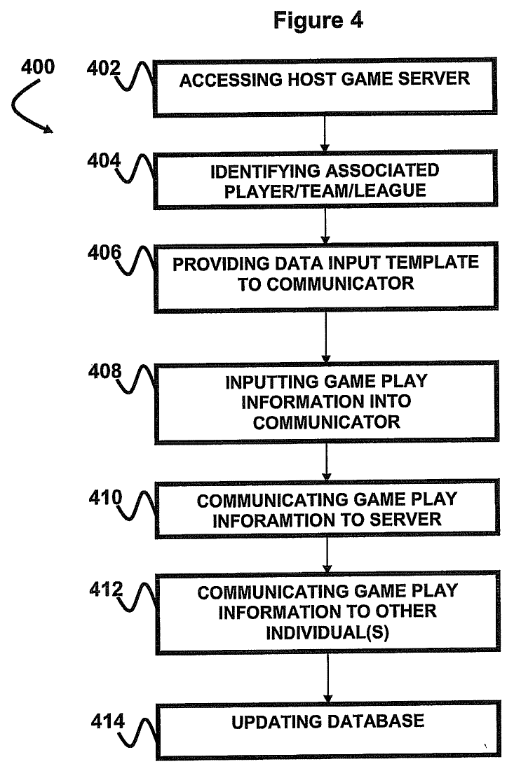

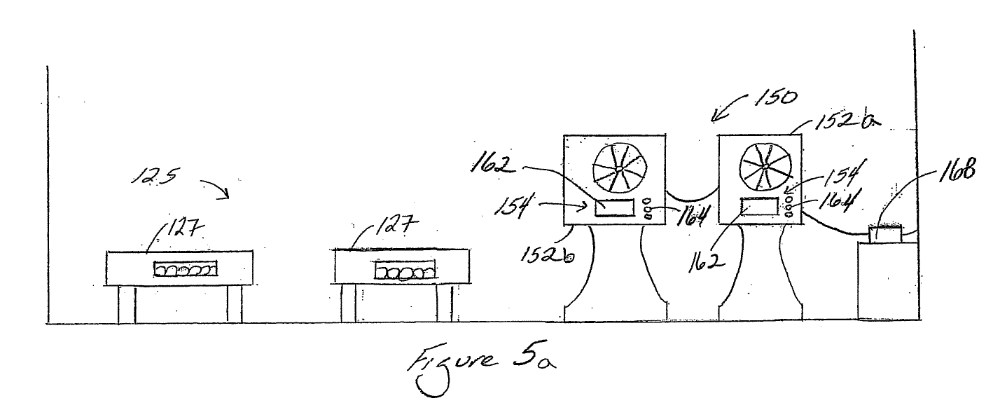

FIG. 4 illustrates a flow chart of a method 400 for reporting game play information utilizing worldwide web accessibility according to an embodiment of the present invention. At 402, a player or other individual may access the host game server 106 through the use of a communicator, which may be a personal computer or a computer located at the facility hosting the game play that has a communication interface configured to provide wired or wireless access to the internet so that the user may log into the host game server 106. According to certain embodiments, the communication interface may be a modem, wireless adapter, or wireless router, among others. Further, a wireless embodiment may utilize a WiFi radio signal, Ethernet connection, or an 802.11 networking standard, among others. Further, according to such an embodiment, the user interface may include a display and at least one player switch, such as a keyboard or a touch screen enabled display, among others.

At 404, the host game server 106 may use the information inputted by individual at 402 or detected by the host game server 106 to identify, or verify the identity of, the individual, associated team, and/or league. At 406, the host game server 106 may provide a game play template for the individual to input game play information. According to some embodiments, the host game server 106 may format the template for data input by utilizing a variety of player and/or league information. For example, the game play template may be provided to, or viewable by, the player with information regarding the game time, identification of the players and/or teams involved, and/or the type of game played so that the fields for data input are formatted so that the details of the game play information are to be inputted at specified locations.

At 408, the individual may input the game play information into the communicator. At 410, the game play information inputted into the communicator may be communicated through the use of the communication interface to the host game server 106. At 412, the host game server 106 may communicate the inputted game play information to other players, such as an opposing team captain, for review, validation, and/or edits. For example, the inputted game play information may be communicated to the opposing team captain by e-mail or as an SMS text message. Alternatively, time limits may be set for the period in which a player is allowed to input game play information and time in which an opposing player is allowed to review, validate, and/or edit the inputted game play information. For example, the team captain for the winning team may be assigned a specific week day(s), or a span of designated hours, to input and communicate the game play information to the host game server 106, while the opposing player may be assigned a subsequent week day(s), or a later span of hours, to review, verify, and/or edit the communicated game play information. If the communicated game play information is verified, and/or the opponent does not verify, edit, and/or dispute the communicated information during an allotted time, then at 414 the communicated game play information may be used by the host game server 106 to update the database or other records. If, however, a player edits the communicated game play information, the host game server 106 may communicate those changes for review, verification, and/or editing to the individual who originally inputted the game play information or some other designated individual. Disputes or protests regarding the communicated or edited game play information can be recorded and/or communicated, for example via e-mail or SMS text message, to a league manager for subsequent action.

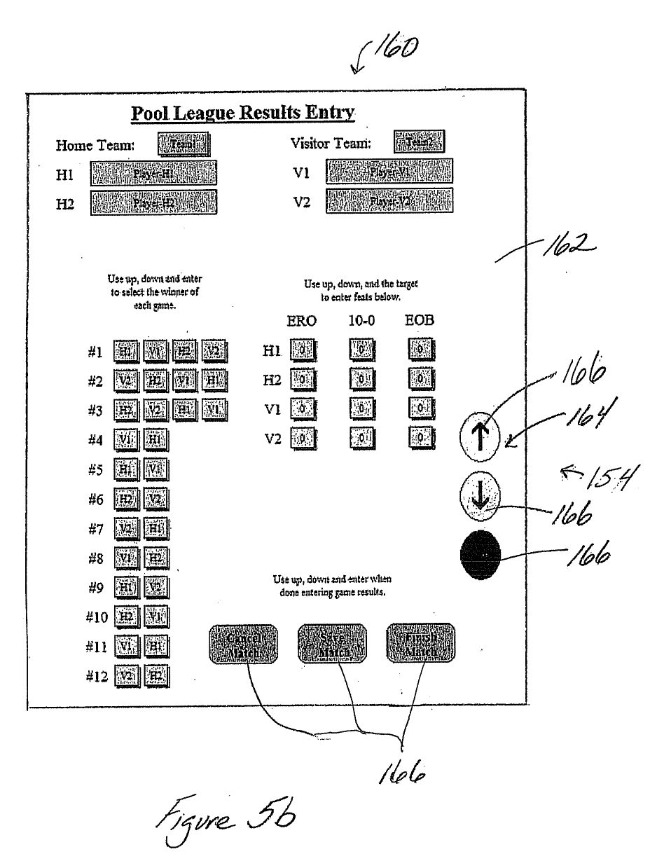

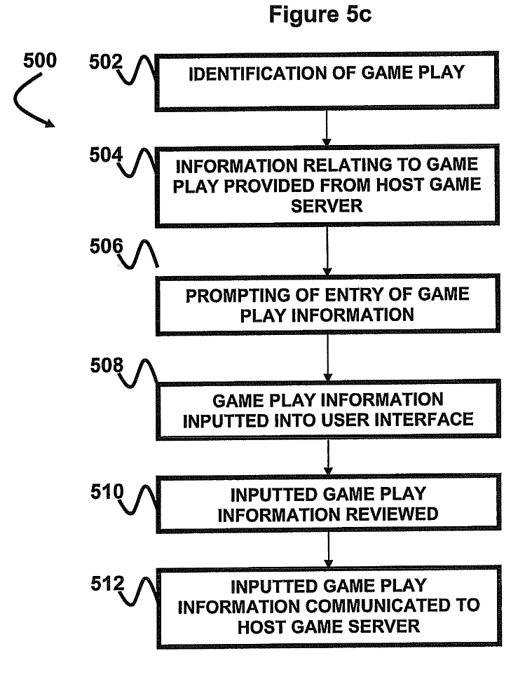

FIG. 5a illustrates an embodiment of the present invention in which a second entertainment system 150 is used for communicating information relating to game play at a first entertainment system 125 according to an embodiment of the present invention. The first entertainment system 125 may include at least one game unit 127, such as a billiard table, dartboard, and hockey based table game, among others. The second entertainment system 150 may include at least one game unit 152 and a user interface 154. The game units 127 of the first entertainment system 125 may be the same type, or may be a different type, than the game unit 152 of the second entertainment system 150. For example, although FIG. 5a illustrates the game units 127 of the first entertainment system 125 as billiard tables, and the game units 152 of the second entertainment system 150 as dartboard games, according to certain embodiments, the game units 127, 152 may all be billiard tables or all be dart board games, or may each be combination thereof.

The user interface 154 may include at least one player input switch 164, a central processor, and a display 162. The player input switch 164 may be a keyboard, keypad, or buttons or switches that allow the player to input game play information in the user interface 154. According to other embodiments, the player input switch 164 may be a touch screen that enables the player to input information into the user interface 154 by touching various portions or sections of the display. For example, according to the embodiment illustrated in FIG. 5c, a touch screen having a touch sensitive membrane or touch sensitive panels 166 allow an individual to input a variety of game play information into the user interface 154.

The second entertainment system 150 may also include at least one system communicator 168. The system communicator 168 may include a control board, a power source, and memory storage. The power source may be utility power supplied to the facility, be at least one battery, a solar power cell, or the like. According to certain embodiments of the present invention, each game unit 152 may include system communicator 168. Alternatively, a system communicator 168 may be shared by more than one game unit 152a. For example, the system communicator 168 may be operably connected to, such as by a wired or wireless connection, or be housed within a game unit 152a that receives game play information that has been inputted into the user interface of another game unit 152b. According to certain embodiments, a game unit 152a may be configured to wireless communicate game play information, for example by transmitting an RF signal from an antenna, to a receiver of a system communicator 168. Accordingly, the system communicator 168 may be located remotely from the game unit 152, or may be located in fewer than all of the game units 152.

The system communicator 168 of the second system 150 may be operably connected to host game server 106, such as through the use of wires or a wireless connection, such as by a modem, bus line, RS485 interface, Ethernet connection, or WiFi radio system, among others.

FIG. 5b illustrates an example of a game play template 160 displayed on the display 162 of the user interface 154 according to one embodiment of the present invention. The template 160 may provide fields for inputting player identification information, such as player names (H1, H2, V1, V2) and teams (Team1, Team2). However, this information may be provided in the template by the host game server 106, as discussed below. The template 160 may present the option of entering game feats or accomplishments such as eight ball run out (ERO), ten-zero (10-0) and eight on the break. Further, the host game server 106 may provide a template having game-specific accomplishments that is tailored for the specific type of game play that is occurring, such as nine ball run out and nine on break of games of nine ball, among others.

FIG. 5c illustrates a flow chart of a method 500 for reporting game play information at a first entertainment unit 125 utilizing the communication capabilities of a second entertainment system 150 according to an embodiment of the present invention. At 502, during or at the conclusion of game play, a player(s) or other individual may identify or select the type of game play for entry into the user interface 154 of a second entertainment system 150. For example, at the user interface of a second entertainment unit 150, a team captain may select a menu relating to the game play at the game unit(s) 127 of the first entertainment system 125, such as a pool league menu. Alternatively, a player may input identification information at the user interface 154, for example, a player, team, league name, game unit 127 being played, scheduled game time, or the entry of a password or code.

At 504, using information provided by the identification of game play at 502, the host game server 106 may provide to the user interface 154 information related to the game play at the first entertainment system 125, such as identification of each player, team, and/or opponent names. For example, if player identification information is provided, the host game server 106 may reference the league schedule to identify that player's team and/or the opponent. At least some of the information provided from the host game server 106 may be provided with the template for recording game play information. At 506, the user interface may prompt the player for entry of game play information at the user interface 154.

At 508, the player may input game play information at the user interface 154 using the player input switch 164. At 510, the inputted game play information may be reviewed, edited, and validated by the player, opponent, or other interested party before the results are communicated to the host game server 106. At 512, the inputted game play information is communicated to the host game server 106. The communication of the inputted game play information may occur at different times. For example, according to certain embodiments, the communication of the inputted game play information may occur following the game play information being inputted into the user interface 154. According to certain embodiments, the inputted game play information may be communicated with the host game server 106 at a later time, such as after contact is established between the host game server 106 and the system communicator 168 during a scheduled contact time.

According to certain embodiments of the present invention, after the host game server 106 has received inputted game play information from the system communicator 168, the communicated game play information may be reviewed and/or approved by a league coordinator. Further, after the host game server 106 has received game play information, or, if desired, after the league coordinator has approved the inputted information, the information may be available for access by others. For instance, according to embodiments in which the game play information is part of a league, tournament, or other competitive play, inputted game play results and/or other updated player or league information, such as standings and/or rankings, among others, may be available for viewing through the league host server 106. Alternatively, this information may be downloaded for viewing at the display 162 of the game unit 152 of the second entertainment system 150. According to other embodiments, this information and/or notification of its availability for viewing may be sent to the communicator 104 of at least some of the participants of game play in the form of text messages and/or e-mail.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of communicating game play information to a host game server comprising:
engaging in game play at a game unit;
inputting game play information into a communicator, the game play information corresponding to the game play at the game unit, the communicator including a communication interface and a user interface;
providing information allowing the host game server to identify the source of the inputted game play information;
communicating the inputted game play information to the host game server; and
recording the inputted game play information by the host game server.

2. The method of claim 1 further including requesting a game play template from the host game server.

3. The method of claim 2 further including communicating the game play template from the game host server to the communicator.

4. The method of claim 3 further including referring to a league schedule to format the requested game play template to provide player and opponent information before the game play template is communicated from the host game server to the communicator.

5. The method of claim 1 wherein the game unit is a billiard table.

6. The method of claim 5 wherein the communicator is a hand-held portable electronic device.

7. The method of claim 6 wherein the communicator is a cellular telephone.

8. The method of claim 7 wherein the communicating of the inputted game play information comprises transmitting a Short Message Service text message from the communicator to the host game server.

9. The method of claim 7 wherein the communicating of the inputted game play information comprises transmitting a Wireless Application Protocol formatted message from the communicator to the host game server.

10. The method of claim 7 wherein the communicating of the inputted game play information comprises transmitting a Wireless Markup Language formatted message from the communicator to the host game server.

11. The method of claim 7 wherein the communicating of the inputted game play information comprises transmitting a Multimedia Messaging Service formatted message from the communicator to the host game server.

12. The method of claim 7, wherein providing identification information comprises identification of the telephone number of the communicator.

13. The method of claim 7 wherein inputting game play information comprises utilizing codes to identify game play information.

14. The method of claim 5 wherein the communicating of the inputted game play information comprises communicating game play information over the internet.

15. The method of claim 1 further including verifying the accuracy of the inputted game play information by a competitor of the game play.

16. The method of claim 1 further including generating a league report using recorded game play information.

17. The method of claim 16 further including communicating at least a portion of the generated league report to the communicator.

18. A method of communicating game play information to a host game server comprising:
requesting a game play template from the host game server;
engaging in game play at a billiard table;
inputting game play information into a communicator, the inputted game play information corresponding to game play at the billiard table, the communicator being a cellular telephone having a communication interface and user interface, the user interface including a display and at least one player input switch;
providing caller identification information allowing the host game server to identify the source of the inputted game play information;
communicating the inputted game play information to the host game server;
recording the inputted game play information by the host game server; and
communicating the recorded game play results to at least a portion of the participants of the game play.

19. The method of claim 18 further including referring to a league schedule to format the game play template to provide player and opponent information.

20. The method of claim 18 wherein the communicating of the inputted game play information comprises transmitting a Short Message Service text message from the communicator to the host game server.

21. The method of claim 18 wherein the communicating of the inputted game play information comprises transmitting a Wireless Application Protocol formatted message from the communicator to the host game server.

22. The method of claim 18 wherein the communicating of the inputted game play information comprises transmitting a Wireless Markup Language formatted message from the communicator to the host game server.

23. The method of claim 18 wherein the communicating of the inputted game play information comprises transmitting a Multimedia Messaging Service formatted message from the communicator to the host game server.

24. A method of communicating game play information to a host game server comprising:
engaging in game play at a game unit of a first entertainment system;
inputting game play information into the user interface of a game unit of a second entertainment system, the user interface including a display and at least one player switch, the inputted game play information corresponding to game play at the game unit of the first entertainment system, the second entertainment system including a system communicator;
providing information allowing the host game server to identify the source of the inputted game play information;
communicating the inputted game play information to the host game server; and
recording the inputted game play information by the host game server.

25. The method of claim 24 wherein the game unit of the first entertainment system includes at least one billiard table and the game unit of the second entertainment system includes at least one dartboard.

26. The method of claim 24 further including generating a league report using recorded game play information.

27. The method of claim 26 further including communicating at least a portion of the generated league report to the communicator.
